(19) United States
(12) Patent Application Publication
(10) Pub. No.: US 2010/0279105 A1
(43) Pub. Date: Nov. 4, 2010

(54) Coated Magnetic Particles, Composite Magnetic Materials and Magnetic Tapes Using Them

(75) Inventors: Jeffrey Pyun, Tucson, AZ (US); Bryan Korth, Tucson, AZ (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Arizona Board of Regents on Behalf of The University of Arizona, Tucson, AZ (US)

(21) Appl. No.: 12/761,210

(22) Filed: Apr. 15, 2010

Related U.S. Application Data
(60) Provisional application No. 61/212,716, filed on Apr. 15, 2009.

(51) Int. Cl. H01F 1/26; B05D 5/00; B32B 5/16

(52) U.S. Cl. 428/327; 427/130; 427/127; 252/62.54

(57) ABSTRACT

The invention relates to polymer coated magnetic particles for magnetic tape storage. The invention also describes methods for making the particles and magnetic tape compositions comprising the coated particles.

### CROSS-REFERENCE TO RELATED APPLICATIONS

This application claims the benefit under 35 U.S.C. §119(e) of the filing date of U.S. Provisional Application Serial No. 61/212,716, filed Apr. 15, 2009, which is hereby incorporated herein by reference in its entirety.

The invention relates to polymer coated magnetic particles, methods for making the particles, and magnetic tape compositions comprising the coated particles.

### BACKGROUND OF THE INVENTION

The use of dipolar particles as building blocks to prepare organized hierarchical materials is an emerging area of great potential in materials chemistry. Ferromagnetic colloids are of interest for this application, as the inherent dipole moment of these materials enables one- and two-dimensional assembly into novel mesostructures.

Magnetic assemblies have been reported using both ferromagnetic and superparamagnetic particles on supporting surfaces to form 1-D chains, flux closure rings, 2-D superlattices of closed packed nanocrystals, and 3-D labyrinth-like suprastructures. Additionally, organized assemblies of magnetic nanoparticle building blocks have also been directly observed in solution using cryogenic electron microscopy and atomic force microscopy of assemblies at crosslinkable oil-water interfaces.

One of the basic challenges of studying and utilizing these materials is obtaining appreciable quantities of ferromagnetic particles possessing uniform size and well-defined magnetic properties.

Sub-micron sized magnetic metal particles suitable for forming a recording layer on a flexible magnetic medium or tape are commonly manufactured in sintered clusters of oxide coated metal particles. The oxide layer imparts chemical stability to the metal particles. The oxide layer also stabilizes the metal core, but reduces the volume fraction of the magnetic particle available to contribute to the magnetic domain which is needed to store information. The oxide layer is formed in a sintering process that also cements individual magnetic particles into clusters held together by the hard oxide material. This makes dispersion of the particles into the individual magnetic particles very difficult if not impossible. As a result, processing of these particles into suspensions suitable for creation of a useful recording layer on a flexible substrate is becoming increasingly difficult to achieve as the particles become smaller. Flocculation and agglomeration of magnetic particles can occur, resulting in relatively poor tape performance and limiting the maximum achievable information density.

### SUMMARY OF THE INVENTION

In one aspect, the invention provides a coated magnetic particle, comprising a magnetic particle; and a free radical polymerized polymer disposed about the magnetic particle, the free radical polymerized polymer comprising a polymer chain and at least one liganting group disposed at an end of the polymer chain.

In another aspect, the invention provides a free radical polymerized polymer comprising a polymer chain and at least one liganting group disposed at an end of the polymer chain.

In another aspect, the invention provides a composite magnetic material comprising a plurality of coated magnetic particles as described herein, dispersed in a polymeric binder.

In another aspect, the invention provides a magnetic medium, comprising the composite magnetic material as described herein disposed on a backing

In another aspect, the invention provides a method for preparing coated magnetic particles comprising contacting magnetic particles with a solution comprising a free radical polymerized polymer, wherein the free radical polymerized polymer comprised a polymer chain and at least one liganting group disposed at an end of the polymer chain.

In another aspect, the invention provides a method for preparing a magnetic medium comprising coating a backing with a composition comprising the coated magnetic particles of the invention and an optional binder to provide a coated backing; exposing the coated backing to a magnetic field orientation treatment to provide an oriented coated backing; and drying the oriented coated backing

### BRIEF DESCRIPTION OF THE DRAWINGS

The accompanying drawings are not necessarily to scale, and sizes of various elements can be distorted for clarity.

FIG. 1 is a schematic cross-sectional view of a coated magnetic particle as described herein;

FIG. 2 is a schematic representation of the interaction of a free radical polymerized polymer associating with the surface of a magnetic particle as described herein;

FIG. 3 is a schematic representation of a coated magnetic particle coated with free radical polymerized polymer at relatively high surface densities as described herein; and

FIG. 4 is a GPC of the free radical polymerized polymer of Example 4.

### DETAILED DESCRIPTION OF THE INVENTION

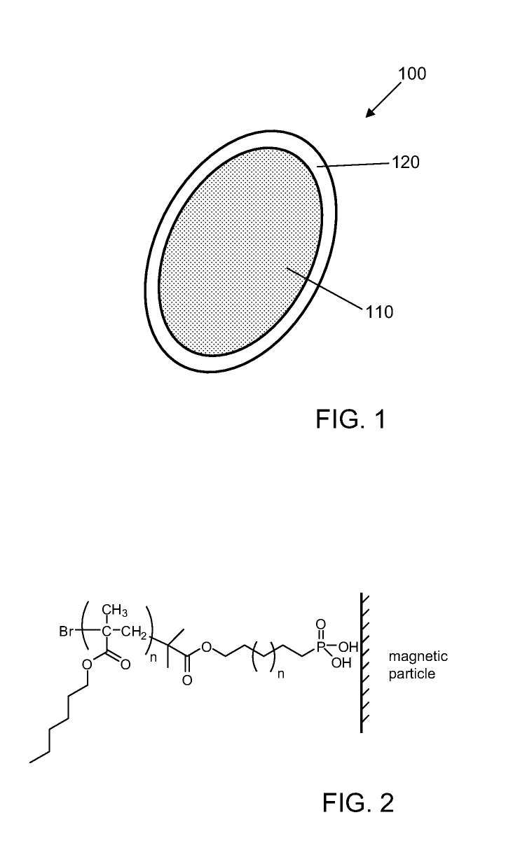

One aspect of the invention provides a coated magnetic particle, comprising a magnetic particle; and a free radical polymerized polymer disposed about the magnetic particle, the free radical polymerized polymer comprising a polymer chain and at least one liganting group disposed at an end of the polymer chain, the liganting group being selected from —COOH, —CONH₂, —PR⁷₂, —P(O)R⁷₂, —SH, —P(O)(OH)₂, —S(O)₂OH, —NH₂, and salts thereof, in which each R⁷ is independently H or C₁-C₂₀ alkyl. FIG. 1 is a schematic cross-sectional view of a coated magnetic particle according to one embodiment of the invention. Coated magnetic particle 100 includes magnetic particle 110 and free radical polymerized polymer 120 disposed about the magnetic particle.

Free radical polymerized polymers suitable for use in the coated magnetic particles described herein can have a wide range of molecular weights. Unless otherwise defined, polymers molecular weights noted herein are weight-averaged molecular weights (M_{w}). Particular polymers useful in the invention are those having molecular weights in the range of from about 1,000 to about 100,000 g/mol. Other particular polymers have molecular weights from about 5,000 to about 50,000 g/mol. In still other embodiments, the molecular weight of the polymer is about 10,000 to about 20,000 g/mol. In still other embodiments, the molecular weight of the polymer is about 16,000 g/mol. Mixtures of polymers with different molecular weights can also be used.

The free radical polymerized polymer can have a polydispersity less than 5. In one embodiment, the free radical polymerized polymer has a polydispersity less than 2. In yet another embodiment, the free radical polymerized polymer has a polydispersity less than 1.5. In one embodiment, the polydispersity is about 1.2. Polydispersity can be calculated as the quotient of M_{w} and number-averaged molecular weight (MO, as is familiar to the person of skill in the art.

A wide variety of types of polymers can be used as the polymer chain of the free radical polymerized polymers used herein. The polymer chain can be, for example, a poly(styrene), a poly(methacrylate) (such as a poly(C₁-C₁₀alkyl methacrylate)), a poly(acrylate) (such as a poly(C₁-C₁₀alkyl acrylate)), a poly(acrylonitrile), a poly(vinyl pyridine), a poly(vinyl pyrrolidine), a poly(vinyl chloride), a poly(vinyl ester), a poly(vinyl phosphonic acid), a poly(vinyl phosphonate), a poly(acrylic acid), a poly (methacrylic acid), a poly(diene), or a copolymer thereof, or a mixture thereof. For example, in certain embodiments the polymer chain can be a polymer of vinyl- or (meth)acrylate-capped polyether, polyester, polysiloxane, or bisphenol.

In one embodiment of the coated magnetic particles as described herein, the polymer chain is a poly(styrene). In another embodiment, the polymer chain is a poly(alkyl (meth)acrylate) such as poly(methyl methacrylate), poly(hexyl methacrylate) or poly(butyl methacrylate).

The polymer chain of the free radical polymerized polymer used herein can be a block copolymer comprising two or more polymer subunits. For example, in certain embodiments the polymer chain can be poly(methyl methacrylate)-block-poly(oligoethylene glycol)methacrylate, polystyrene-block-poly(butyl acrylate), polystyrene-block-poly(methyl methacrylate), or polymethyl methacrylate-block-poly(ethylene oxide). Especially desirable block copolymers are described, for example, in U.S. Patent Application Publication no. 2010/0015472, entitled “PROTECTIVE COATING OF MAGNETIC NANOPARTICLES” and published on Jan. 21, 2010, which is hereby incorporated herein by reference in its entirety. For example, the polymer chain can have a first block and a second block, the first block being disposed between the head moiety and the second block, the first block forming a glassy first phase, the second block forming a rubbery second phase; the glassy first phase including an inner surface facing towards the particle and an outer surface opposite the inner surface and facing away from the particle, the inner surface being in direct contact with the particle, the rubbery second phase being coupled to the outer surface; the glassy first phase comprising a hydrophobic copolymer having a glass transition temperature of at least 50° C.; and the rubbery second phase comprising a polymer having at least one of (i) a glass transition temperature of no greater than 30° C., and (ii) a tan delta peak maximum of no greater than 30° C. Specific examples of polymer chains include, for example, (i) poly(methyl methacrylate)-block-poly(oligoethylene glycol) methacrylate; (ii) polystyrene-block-poly(butyl acrylate); and (iii) polymethyl methacrylate-block-poly(ethylene oxide). For poly(methyl methacrylate)-block-poly(oligoethylene glycol) methacrylate, the poly(methyl methacrylate) will form the hard inner shell on the particles, and the ethylene glycol will form the rubbery outer shell. For polystyrene-block-poly(butyl acrylate), the polystyrene will form the hard inner shell on the particles, and the butyl acrylate will form the rubbery outer shell. For poly(methyl methacrylate)-block-poly(ethylene oxide), the poly(methyl methacrylate) will form the hard inner shell on the particles, and the ethylene oxide will form the rubbery outer shell.

The free radical polymerized polymer can have a variety of glass transition temperatures, which will be chiefly determined by the identity of the polymer chain. The person of skill in the art will select the glass transition temperature, for example, for compatibility with a desired binder material as described herein. For example, in certain embodiments, the free radical polymerized polymer has a glass transition temperature greater than about 50° C. Examples of such polymer chains include poly(methyl methacrylate) and poly(styrene). In other embodiments, the free radical polymerized polymer has a glass transition temperature less than about 10° C. An example of such a polymer is poly(hexyl methacrylate).

The free radical polymerized polymer can be coated on the magnetic particle at a thickness in the range of about 1 nm to about 1000 nm. In certain embodiments, the thickness of the free radical polymerized polymer is in the range of about 1 nm to about 500 nm. In another embodiment, the free radical polymerized polymer is coated on the magnetic particle at a thickness in the range of about 2 nm to about 200 nm.

In certain embodiments of the coated magnetic particles as described herein, the coated particle is in the range of about 1% to about 99% polymer by weight. For example, in certain embodiments the coated particle is in the range of about 10% to about 90% polymer by weight. In another embodiment, the coated particle is in the range of about 20% to about 80% polymer by weight.

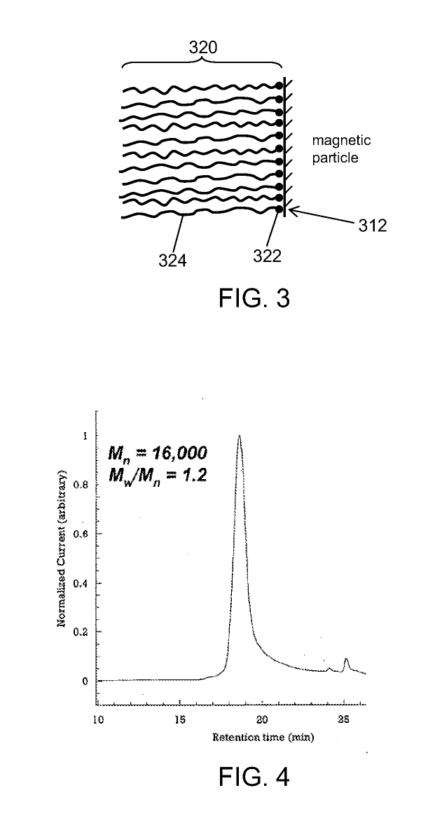

Coating thickness can be controlled by the person of skill in the art, for example, by controlling the molecular weight (and hence the polymer chain length) of the free radical polymerized polymer. In certain embodiments, the free radical polymerized polymer is disposed substantially as a monolayer, i.e., with the liganting group associated with the surface of the magnetic particle as described herein, and the polymer chain extending away therefrom. By increasing the relative amount of polymer, the person of skill in the art can provide high surface coverage of the magnetic particle with liganting groups, and therefore a relatively high density of polymer chains around the particle, resulting in relatively higher ratios of polymer to magnetic particle and relatively higher thicknesses. While not intending to be bound to any particular theory, the inventors surmise that at sufficient magnetic particle surface densities of liganting groups, the polymer chains extend away from the magnetic particle surface in a brush-like arrangement, as shown in FIG. 3. In FIG. 3, the free radical polymerized polymer 320 is disposed substantially as a monolayer. The head moieties 322 are associated with the surface 312 of the magnetic particle, with the polymer chains 324 extending therefrom.

In certain embodiments of the coated magnetic particles as described herein, the liganting group is associated with a surface of the magnetic particle. For example, the liganting groups of the individual polymer chains can be within 0.2 nm of the surface of the magnetic particle. The liganting groups can make a covalent, non-covalent, electrostatic, or coordinative bond with the surface of the magnetic particle. For example, in certain embodiments the association is a covalent bond between a liganting group (e.g., phosphonic or phosphoric acid) and a would define the type of association as either covalent bonds between phosphonic acids and metal oxide surface of the magnetic particle (e.g., intentionally oxide passivated, or adventitious oxide surface layers). Non-covalent interactions include, for example, ionic, hydrogen bonding, van der Waals, or some combination thereof. Magnetic particle-liganting group interactions can be determined using a variety of techniques, such as vibrational spectroscopy (e.g., IR), or photoelectron spectroscopy. An example of the association of the free radical polymerized polymer with the surface of the magnetic particle is shown schematically in FIG. 2.

In certain embodiments of the coated magnetic particles as described herein, the liganting group of the coated magnetic particles as described herein is —CONH₂, —PR⁷₂, —SH, —P(O)(OH)₂, —S(O)₂OH, and salts thereof, in which each R⁷ is independently H or C₁-C₂₀ alkyl. In one embodiment of the coated magnetic particles as described herein, the liganting group is —P(O)(OH)₂ or a salt thereof. As the person of skill in the art will appreciate, the liganting group can be a phosphonate (e.g., —CH₂—P(O)(OH)₂); or a phosphate (e.g., —CH₂—O—P(O)(OH)₂).

In one embodiment of the coated magnetic particles as described herein, the liganting group is part of a head moiety disposed at the end of the polymer chain of the free radical polymerized polymer. The head moiety can, for example, provide a linker between the liganting group and the polymer chain. As the person of skill in the art will understand, the linker will depend on the particular chemistry used to bond the liganting group to the polymer chain. The linker can include, for example, a straight chain alkylene or a poly(ethylene glycol) at least eight atoms in length. Such chains can allow relatively tight packing at the particle surface, and thereby increase surface coverage.

For example, in certain embodiments of the coated magnetic particles as described herein, the head moiety has the structure -Q-(Y)ₖ-A, wherein
A is selected from —COOH, —CONH₂, —PR⁷₂, —P(O)R⁷₂, —SH, —P(O)(OH)₂, —S(O)₂OH, —NH₂, and salts thereof, in which each R⁷ is independently H or C₁-C₂₀ alkyl;
k is in the range of 2-28;
each Y is independently selected from —O—, —C(R¹)(R²)—, —N(R³)—, wherein each R¹ and R² is independently selected from H, C₁-C₃ alkyl, O(C₁-C₃ alkyl), or R¹ and R² come together to form ═O, and each R³ is H, C₁-C₃ alkyl or —CO—(C1-C3 alkyl), provided that no two adjacent Y are —O— or —N(R³)—;
Q is selected from —C(R⁴)(Ar)—, —C(R⁴)(Ar)—CO(T)—, —C(R⁴)(R⁵)—CO(T)—, —C(R⁴)(CN)—, —C(R⁴)(CO(T)(R⁵))—, wherein Ar is aryl or heteroaryl, T is —O—, —N(R⁶)— or a bond, and each R⁴, R⁵ and R⁶ is independently H or C₁-C₃ alkyl.

In certain embodiments of the coated magnetic particles as described herein, the head moiety has the structure -Q-(Y)ₖ-A, wherein A is selected from —CONH₂, —PR⁷₂, —SH, —P(O)(OH)₂, —S(O)₂OH, and salts thereof, in which each R⁷ is independently H or C₁-C₂₀ alkyl. In other embodiments of the coated magnetic particles as described herein, the head moiety has the structure -Q-(Y)ₖ-A, wherein A is —P(O)(OH)₂.

In particular embodiments of the coated magnetic particles as described herein, the head moiety has the structure -Q-(Y)ₖ-A, wherein k is in the range of 5-24. In other embodiments of the coated magnetic particles as described herein, k is in the range of 8-20.

In certain embodiments of the coated magnetic particles as described herein, the head moiety has the structure -Q-(Y)ₖ-A, wherein each Y is —CH₂—. For example, in these embodiments of the coated magnetic particles as described herein, —(Y)ₖ— is —(CH₂)ₖ—, in which k is as described above.

In other embodiments of the coated magnetic particles as described herein, the head moiety has the structure -Q-(Y)ₖ-A, wherein three Y moieties form —CH₂CH₂O— or —OCH₂CH₂—. For example, in these embodiments of the coated magnetic particles as described herein, —(Y)ₖ— is —(CH₂CH₂O)ₘ— or —(OCH₂CH₂)ₘ—, in which m is in the range of 2-9.

In certain embodiments of the coated magnetic particles as described herein, the head moiety has the structure -Q-(Y)ₖ-A, wherein Q is —C(R⁴)(R⁵)—CO(T)-, wherein T is —O— or a bond, and each R⁴ and R⁵ is independently H or C₁-C₃ alkyl. For example, in these embodiments of the coated magnetic particles as described herein, Q is —C(CH₃)₂—CO(O)— or —C(CH₃)₂—CO—. In other embodiments of the coated magnetic particles as described herein, Q is —CH(CH₃)—CO(O)— or —CH(CH₃)—CO—.

In certain embodiments of the coated magnetic particles as described herein, the head moiety has the structure -Q-(Y)ₖ-A, wherein Q is —C(R⁴)(CN)—, wherein R⁴ is H or C₁-C₃ alkyl. For example, Q is —CH(CN)— or —C(CH₃)(CN)—.

In particular embodiments of the coated magnetic particles as described herein, the head moiety has the structure -Q-(Y)ₖ-A, wherein Q is —C(CH₃)₂—CO(O)—, —C(CH₃)₂—CO—, —CH(CH₃)—CO(O)—, —CH(CH₃)—CO—, —CH(phenyl)—CO(O)—, —CH(phenyl)—CO—, —CH(CN)—, —C(CH₃)(CN)—, —CH(phenyl)—, —C(CH₃)(phenyl)-,

In yet another embodiment, the disclosure provides a coated magnetic particle wherein the head moiety has the structure

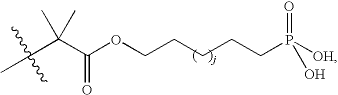

in which j is in the range of 1-20.

Another aspect of the invention is a polymeric material comprising a polymer chain and a head moiety disposed at the end of the polymer chain. The polymer chain and head group are as described herein.

The magnetic particle can be any type of particle suitable for its intended purpose. For example, any metallic (e.g., Fe, Co, Ni), bimetallic/multi-metallic alloy (e.g., FeCo, FePt, CoPt), metal oxide (e.g., all spinel ferrites-barium ferrite, cobalt ferrite, magnetite), metal nitrides (e.g., iron nitride), can be used in practicing the various aspects of the present invention. In certain embodiments of the coated magnetic particles as described herein, the magnetic particle is a Fe or Co magnetic particle. In other embodiments, the magnetic particle is a ferromagnetic oxide passivated FeCo alloy particle. Magnetic particles are available, for example, from Dowa Electronics Materials Co., Ltd. Other magnetic materials can be used. For example, in certain embodiments, other ferromagnetic particles or ferromagnetic particles can be used.

In certain embodiments of the coated magnetic particles as described herein, the magnetic particles have an average diameter in the range of about 1 nm to about 1000 nm. In certain embodiments, for example, the average magnetic particle diameter is in the range of about 2 nm to about 200 nm. In other embodiments, the average magnetic particle diameter is in the range of about 2 nm to about 60 nm. In certain embodiments, the magnetic particle has no dimension greater than 500 nm; no dimension greater than 100 nm, or even no dimension greater than 40 nm. The person of skill in the art will select the appropriate particle size for the desired end use.

The coated magnetic particles as described herein can be prepared by disposing the free radical polymerized polymer about the magnetic particle to provide the polymer as a thin coating (in certain embodiments in the range of about 1 nm to about 5 nm, e.g., about 2 nm in thickness). The polymers themselves can be made by a variety of techniques, as would be apparent to the person of skill in the art. For example, in certain embodiments, and as described in the Examples, atom transfer radical polymerization (ATRP) can be used to form the polymer. For example, as described in the Examples, a halo-substituted head moiety, monomer, and an ATRP catalyst are reacted under ATRP conditions, to obtain the free radical polymerized polymer, which is then disposed about the magnetic particle. Other suitable methods that the person of skill in the art can used to make the free radical polymerized polymers as described herein include, for example, the methods of Matyjaszewski via solid supported catalysts, techniques using emulsion based systems, and other processes where the catalyst can be used in very small quantities, or easy removed.

The coated magnetic particles as described herein can have enhanced dispersion and chemical stability. For example, in certain embodiments, the invention provides a higher yield and dispersion of primary, non-flocced metallic particles and similar primary particle dispersion when blended with a polymer binder.

In another aspect, the invention provides composite magnetic materials comprising a plurality of coated magnetic particles according to the invention, dispersed in a polymeric binder. Suitable binders include, for example, polyurethanes, polyvinylesters, polyvinylchlorides, polyvinylacetates, polyimides, and polyepoxides. The person of skill in the art will recognize particular binder materials suitable for use with the coated magnetic particles as described herein.

In one embodiment, a composite magnetic material can contain the polymer chain of the free-radical polymerized polymer is compatibilized with conventional tape binders by controlling hydrophobicity of the free-radical polymerized polymer. For example, the free-radical polymerized polymer can be compatibilized with binder by controlling the composition and molecular weight of the free-radical polymerized polymer.

For example, in one embodiment, a composite magnetic material as described herein contains the polymer chain of the free-radical polymerized polymer that is formed from at least one monomer that is used in the formation of the polymeric binder. In another embodiment, the free-radical polymerized polymer and the polymeric binder each have at least 50% by weight of common monomer content.

The person of skill in the art can also use solution processing methods using mixed solvent systems to promote selective adsorption to the magnetic particle and promote efficient bridging of the particle filler within a binder matrix.

In another aspect, the invention provides a magnetic medium, comprising the composite magnetic material of the invention disposed on a backing In one embodiment, the backing is flexible backing Suitable backing materials include but are not limited to polyethylene terephthalates (PET), polyethylene naphthalates (PEN) and metalized PETs and PENs.

In another aspect, the invention provides methods for preparing polymer coated magnetic particles comprising contacting magnetic particles with a solution comprising a free radical polymerized polymer, wherein the free radical polymerized polymer and the magnetic particle are as described herein.

In another aspect, the invention provides methods for preparing a magnetic medium comprising coating a backing with a composition comprising the coated magnetic particles of the invention and an optional binder to provide a coated backing; exposing the coated backing to a magnetic field orientation treatment to provide an oriented backing; and drying the oriented backing

The preparation of magnetic media using magnetic particles, binder and backing is familiar to the person of skill in the art, and is described further, for example, in U.S. Pat. No. 3,953,656, which is hereby incorporated herein by reference in its entirety.

In one embodiment of the methods as described herein, the backing is a flexible backing In another embodiment of the methods as described herein, the binder is a polymeric binder. In another embodiment, the binder is a thermosetting polymer. In one embodiment of the methods as described herein, wherein the method further comprises heating the oriented backing to a temperature suitable for setting the thermosetting polymer.

### Definitions

The term “alkyl” as used herein, means a straight or branched chain hydrocarbon containing from 1 to 10 carbon atoms, unless otherwise specified. Representative examples of alkyl include, but are not limited to, methyl, ethyl, n-propyl, iso-propyl, n-butyl, sec-butyl, iso-butyl, tert-butyl, n-pentyl, isopentyl, neopentyl, n-hexyl, 3-methylhexyl, 2,2-dimethylpentyl, 2,3-dimethylpentyl, n-heptyl, n-octyl, n-nonyl, and n-decyl. When an “alkyl” group is a linking group between two other moieties, then it may also be a straight or branched chain; examples include, but are not limited to —CH₂—, —CH₂CH₂—, —CH₂CH₂CHC(CH₃)—, —CH₂CH(CH₂CH₃)CH₂'.

The term “aryl,” as used herein, refers to an aromatic hydrocarbon ring system containing at least one aromatic ring. The aromatic ring may optionally be fused or otherwise attached to other aromatic hydrocarbon rings or non-aromatic hydrocarbon rings. Representative examples of aryl groups include phenyl, naphthyl, anthracenyl 1,2,3,4-tetrahydronaphthalene, indenyl, 2,3-dihydroindenyl, and biphenyl. Preferred examples of aryl groups are phenyl and naphthyl. Most preferred is phenyl.

The term “heteroaryl,” as used herein, means a monocyclic heteroaryl or a bicyclic ring system containing at least one heteroaromatic ring. The monocyclic heteroaryl can be a 5 or 6 membered ring. The 5 membered ring consists of two double bonds and one, two, three or four nitrogen atoms and optionally one oxygen or sulfur atom, or 5 membered ring consists of two double bonds and one oxygen or sulfur atom. The 6 membered ring consists of three double bonds and one, two, three or four nitrogen atoms. The 5 or 6 membered heteroaryl is connected to the parent molecular moiety through any carbon atom or any nitrogen atom contained within the heteroaryl. Representative examples of monocyclic heteroaryl include, but are not limited to, furyl, imidazolyl, isoxazolyl, isothiazolyl, oxadiazolyl, oxazolyl, pyridinyl, pyridazinyl, pyrimidinyl, pyrazinyl, pyrazolyl, pyrrolyl, tetrazolyl, thiadiazolyl, thiazolyl, thienyl, triazolyl, and triazinyl. Representative examples of bicyclic heteroaryl include, but are not limited to, benzimidazolyl, benzofuranyl, benzothienyl, benzoxadiazolyl, benzoxathiadiazolyl, benzothiazolyl, cinnolinyl, 5,6-dihydroquinolin-2-yl, 5,6-dihydroisoquinolin-1-yl, furopyridinyl, indazolyl, indolyl, isoquinolinyl, naphthyridinyl, quinolinyl, purinyl, 5,6,7,8-tetrahydroquinolin-2-yl, 5,6,7,8-tetrahydroquinolin-3-yl, 5,6,7,8-tetrahydroquinolin-4-yl, 5,6,7,8-tetrahydroisoquinolin-1-yl, thienopyridinyl, 4,5 ,6,7-tetrahydrobenzo [c] [1,2,5]oxadiazolyl, and 6,7-dihydrobenzo [c] [1,2,5 ]oxadiazol-4(5H)-onyl.

### EXAMPLES

### Example 1

### Synthesis of 11-Bromo-undecyl-bromo-isobutyrate

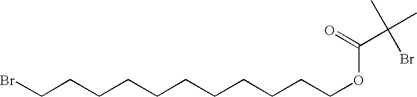

In a round bottom flask equipped with a stir bar was added 11-bromo-undecanol (5.00 g, 19.90 mmol) in a solution of triethylamine (2.02 g, 19.90 mmol) and dichloromethane (DCM) (100 mL) under an argon atmosphere. The solution was chilled in an ice bath prior to the addition of bromo-isobutyryl-bromide (5.77 g, 3.1 mL, 23.88 mmol). The reaction was allowed to warm to room temperature and stirred for 20 hours. Reaction completion was confirmed via NMR by the appearance of a peak at 4.17 ppm (CH₂ adjacent to ester) concomitant with the disappearance of the peak at 3.6 ppm (CH₂ adjacent to OH). The reaction solution was then washed three times with dilute hydrochloric acid (10% by volume), dried over MgSO₄, passed through a silica gel plug and concentrated by rotary evaporation to yield a clear, colorless oil, yield: 8.00 g, 96%. ¹H NMR (500 MHz, CDCl₃): δ 4.17 (2H, t, J=6.6 Hz, CH₂), 3.41 (2H, t, J=7.0 Hz, CH₂), 1.91 (6H, s, CH₃) 1.82 (2H, m, CH₂), 1.68 (2H, m, CH₂), 1.20-1.45 (14H, m, CH₂). ¹³C (500 MHz, CDCl₃) δ 171.6, 66.1, 56.0, 33.9, 32.8, 30.8, 29.5, 29.1, 28.7, 28.3, 28.1, 25.7. m/z found [FAB⁺]: 401.2 [M+H+]

### Example 2

### Synthesis of 11-(diethyl phosphate)-undecyl-bromo-isobutyrate

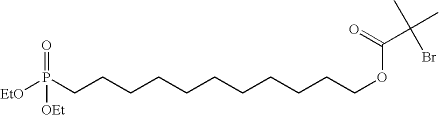

In a round bottom flask equipped with a stir bar and air condenser was added 11-bromo-undecyl-bromo-isobutyrate (2.00 g, 5.00 mmol) and triethyl phosphite (2.49 g, 15.00 mmol). The solution was heated to 145° C. under argon for 20 hours followed by removal of excess phosphite in vacuo (<0.5 ton) at 100° C. to a constant mass. The recovered oil was purified via column chromatography using an eluent of ethyl acetate/MeOH (50:1 v/v) to recover 11-(diethyl phosphate)-undecyl-bromo-isobutyrate as an oil following concentration in vacuo, R_{f}=0.363, yield: 1.9 g, 85%. ¹H (500 MHz, CDCl₃) δ 3.95-4.16 (6H, m), 1.86 (6H, s), 1.49-1.73 (6H, m), 1.13-1.38 (20H, m) ppm. ¹³C NMR (500 MHz, CDC1₃): δ 171.6, 66.1, 61.3 (d, J3.3 Hz), 56.0, 30.8, 30.7, 30.5, 29.5, 29.4, 29.1 (d, J=4.0 Hz), 28.3, 26.3, 25.8, 25.1, 22.4 (d, J=3 Hz), 16.5 (d, J=3 Hz) ppm. m/z found [LCQ]: 459.1 [M+H+]

### Example 3

### Synthesis of 11-(phosphonic acid)-undecylbromo-isobutyrate (11PAUnBIB)

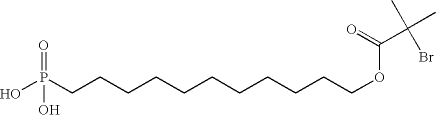

In a round bottom flask equipped with a stir bar was added 11-(diethyl phosphate)-undecyl-bromo-isobutyrate (1.50 g, 3.28 mmol) in dichloromethane (15 mL). Under an argon atmosphere, trimethylbromosilane (2.01 g, 1.70 mL, 13.12 mmol) was added to the room temperature solution over a period of 30 minutes. The solution was allowed to stir at room temperature for 20 hours and quenched by the addition of MeOH (20 mL) followed by concentration via rotary evaporation to afford a colored oil. The process of dilution and concentration was conducted an additional three times, with the final solution dried in vacuo to a clear yellow/brown oil, yield: 1.09 g, 83%. ¹H (CDCl₃) 6 8.14 (2H, b, OH), 4.18 (2H, t, J=6.6 Hz), 1.95 (6H, s), 1.51-1.90 (4H, m), 1.2-1.5 (16H, m) ppm. ¹³C NMR (CDC1₃): δ 171.6, 66.1, 56.0, 30.8, 30.5, 30.3, 29.4, 29.3, 29.2, 29.1, 29.0, 28.3, 25.8, 22.0. m/z found [LCQ] : 402.9 [M+H+]

### Example 4

### Preparation of poly(hexyl methacrylate) from 11PAUnBIB (pHMA-PO₃H₂)

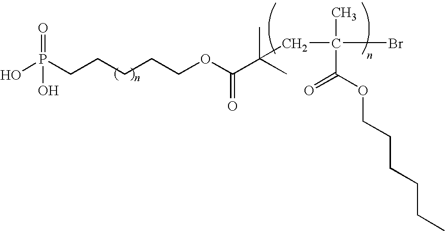

To a Schlenk flask equipped with stirbar was added Cu(I)Cl (0.0144 g, 1.47×10⁻⁴ mol) and dNBpy (0.1202 g, 2.94×10⁻⁴ mol). The solids were degassed by vacuum for 30 minutes followed by argon backfilling. In a separate vial was added hexyl methacrylate (HMA) (2.5 g, 1.47×10⁻² mol)and DMF (1.0 mL). The monomer solution was deoxygenated for 30 minutes by bubbling with argon followed by addition via syringe to the previous degassed solids resulting in a dark red solution. The Schlenk flask was placed in a temperature controlled oil bath at 70° C. for a given period of time as determined by NMR conversion. Upon reaching the desired conversion, the solution was exposed to air and diluted with DCM to give a green/blue solution. The solution was passed through a plug of neutral alumina to remove the copper catalyst resulting in a clear solution that was concentrated to give a tacky, slightly blue colored solid. The tacky solid was dissolved in a minimal amount of DCM and precipitated into cold MeOH (−25° C.) to give a tacky, slightly blue solid. The solid was transferred to a scintillation vial for storage, yield: 1.75 g, 87% at 80% conversion. Polymer characterization: Mₙ=15,900 g/mol, Mₚ=21,000, M_{w}/Mₙ=1.23.

### Example 5

### Preparation of poly(butyl acrylate-random-acrylic acid) (p(BA-r-AA)).

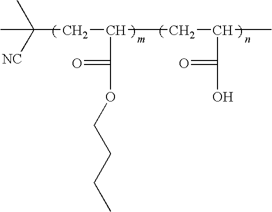

To a round bottom flask equipped with stirbar was added n-butyl acrylate (10.375 g, 8.1×10⁻² mol), acrylic acid (0.292 g, 4.1×10⁻³ mol) and AIBN (0.070 g, 4.25×10⁴ mol). The solution was deoxygenated by bubbling with argon followed by heating in a temperature controlled oil bath at 60° C. for 15 hours. Upon removal, the viscous solution was diluted in DCM (150 mL) and precipitated into stirring cold MeOH (−25 ° C.) to give a colorless, rubbery solid that was transferred to scintillation vials for storage, yield: 8.5 g, 84% at 95% conversion of BA. Polymer characterization: Mₙ=48,000 g/mol, Mₚ=409,800 g/mol, M_{w}/Mₙ=6.91.

### Example 6

### Ligand Adsorption of pHMA-PO₃H₂ on Dowa MP

To a round bottom flask was added Dowa MP Sample A (0.250 g) in degassed toluene (20 mL). In a separate vial was added pHMA-PO₃H₂ (0.500 g, 3.3×10⁻⁵ mol) in degassed toluene (15 mL) followed by sonication to ensure dispersion. The polymer containing solution was added to the MP solution and sonicated at 60° C. for 6 hours to give a homogenous black solution. Following sonication, the solution was divided into four scintillation vials containing steel wool and diluted to 15 mL in CHCl₃ prior to placing next to an external magnetic field until becomes transparent. The CHCl₃ solution was exchanged followed by sonication and magnetic isolation. After removing the second CHCl₃ wash, the polymer coated MP was transferred to tarred scintillation vials by DCM and concentrated to yield a brittle black solid, yield: 0.3535 g, 35% organic by mass, 86% recovery based upon MP mass.

Although specific embodiments have been illustrated and described herein, it will be appreciated by those of ordinary skill in the art that any arrangement that is calculated to achieve the same purpose may be substituted for the specific embodiments shown. This application is intended to cover any adaptations or variations of embodiments of the present invention. It is to be understood that the above description is intended to be illustrative, and not restrictive, and that the phraseology or terminology employed herein is for the purpose of description and not of limitation. Unless clearly excluded by the context, all embodiments disclosed for one embodiment of the invention can be combined with other disclosed embodiments, in any suitable combination. The scope of the embodiments of the present invention should be determined with reference to claims associated with these embodiments, along with the full scope of equivalents to which such claims are entitled.

We claim:

1. A coated magnetic particle, comprising:
a magnetic particle; and
a free radical polymerized polymer disposed about the magnetic particle, the free radical polymerized polymer comprising a polymer chain and at least one liganting group disposed at an end of the polymer chain, the liganting group being selected from —COOH, —CONH₂, —PR⁷₂, —P(O)R⁷₂, —SH, —P(O)(OH)₂, —S(O)₂OH, —NH₂, and salts thereof, in which each R⁷ is H or C₁-C₂₀ alkyl.

2. The coated magnetic particle according to claim 1, wherein the liganting group is associated with a surface of the magnetic particle.

3. The coated magnetic particle according to claim 1, wherein the free radical polymerized polymer is a poly(styrene), a poly(methacrylate), a poly(acrylate), a poly(acrylonitrile), a poly(vinyl pyridine), a poly(vinyl pyrrolidine), a poly(vinyl chloride), a poly(vinyl ester), a poly(vinyl phosphonic acid), a poly(vinyl phosphonate), a poly(acrylic acid), a poly(diene), or a copolymer thereof, or a mixture thereof.

4. The coated magnetic particle according to claim 1, wherein the free radical polymerized polymer is a polymer of vinyl- or (meth)acrylate-capped polyether, polyester, polysiloxane, or bisphenol.

5. The coated magnetic particle according to claim 1, wherein the liganting group is selected from —CONH₂, —PR⁷₂, —SH, —P(O)(OH)₂, —S(O)₂OH, and salts thereof, in which each R⁷ is H or C₁-C₂₀ alkyl.

6. The coated magnetic particle according to claim 1, wherein the liganting group is —P(O)(OH)₂ or a salt thereof

7. The coated magnetic particle according to claim 1, wherein the liganting group is part of a head moiety disposed at the end of the polymer chain of the free radical polymerized polymer.

8. The coated magnetic particle according to claim 7, wherein the head moiety has the structure -Q-(Y)ₖ-A, wherein
A is selected from —COOH, —CONH₂, —PR⁷₂, —P(O)R⁷₂, —SH, —P(O)(OH)₂, —S(O)₂OH, —NH₂, and salts thereof, in which each R⁷ is independently H or C₁-C₂₀ alkyl;
k is in the range of 2-28;
each Y is independently selected from —O—, —C(R¹)(R²)—, —N(R³)—, wherein each R¹ and R² is independently selected from H, C₁-C₃ alkyl, O(C₁-C₃ alkyl), or R¹ and R² come together to form ═O, and each R³ is H, C₁-C₃ alkyl or —CO—(C1-C3 alkyl), provided that no two adjacent Y are —O— or —N(R³)—;
Q is selected from —C(R⁴)(Ar)—, —C(R⁴)(Ar)—CO(T)-, —C(R⁴)(R⁵)—CO(T)-, —C(R⁴)(CN)—, —C(R⁴)(CO(T)(R⁵))—, wherein Ar is aryl or heteroaryl, T is —O—, —N(R⁶)— or a bond, and each R⁴, R⁵ and R⁶ is independently H or C₁-C₃ alkyl.

9. The coated magnetic particle according to claim 8, wherein the head moiety has the structure 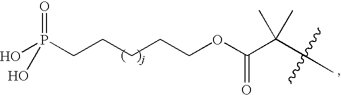
or a salt thereof in which j is in the range of 1-20.

10. The coated magnetic particle according to claim 1, wherein the free radical polymerized polymer has a glass transition temperature greater than about 50° C.

11. The coated magnetic particle according to claim 1, wherein the free radical polymerized polymer has a glass transition temperature less than about 10° C.

12. The coated magnetic particle according to claim 1, wherein the free radical polymerized polymer has a polydispersity less than 2.

13. The coated magnetic particle according to claim 1, wherein the free radical polymerized polymer is coated on the magnetic particle at a thickness in the range of 1 nm-400 nm.

14. The coated magnetic particle according to claim 1, wherein the magnetic particle is a metallic particle, a metal oxide particle, or a metal nitride particle.

15. The coated magnetic particle according to claim 1, wherein the magnetic particle is a ferromagnetic oxide passivated FeCo alloy particle.

16. The coated magnetic particle according to claim 1, wherein the magnetic particle has a diameter in the range of about 2 to about 200 nm.

17. The coated magnetic particle according to claim 1, wherein the coated particle is in the range of about 20% to about 80% polymer by weight.

18. A composite magnetic material comprising a plurality of coated magnetic particles according to claim 1, dispersed in a polymeric binder.

19. A composite magnetic material according to claim 18, wherein the polymer chain of the free-radical polymerized polymer is formed from at least one monomer that is used in the formation of the polymeric binder.

20. A composite magnetic material according to claim 19, wherein the polymer chain of the free-radical polymerized polymer and the polymeric binder each have at least 50% by weight of common monomer content.

21. A magnetic medium, comprising the composite magnetic material according to claim 18 disposed on a backing

22. A method for preparing a magnetic medium, comprising:
coating a backing with a composition comprising the coated magnetic particles of claim 1 and an optional binder to provide a coated backing;
exposing the coated backing to a magnetic field orientation treatment to provide an oriented backing; and
drying the oriented backing

23. The method of claim 22, further comprising heating the oriented backing to a temperature suitable for setting the thermosetting polymer.

24. A method for preparing polymer coated magnetic particles comprising contacting magnetic particles with a solution comprising a free radical polymerized polymer, wherein the free radical polymerized polymer comprises a polymer chain and at least one liganting group disposed at an end of the polymer chain, the liganting group being selected from —COOH, —CONH₂, —PH₂, —P(O)H₂, —SH, —P(O)(OH)₂, —S(O)₂OH, —NH₂, and salts thereof
